(19) United States
(12) Patent Application Publication
(10) Pub. No.: US 2015/0329032 A1
(43) Pub. Date: Nov. 19, 2015

(54) SYSTEM AND METHOD FOR MANUFACTURING A VEHICLE INTERIOR COMPONENT HAVING AN EMBEDDED RADIO FREQUENCY IDENTIFICATION TAG

(71) Applicant: JOHNSON CONTROLS TECHNOLOGY COMPANY, Holland, MI (US)

(72) Inventors: Eric B. MICHALAK, Northville, MI (US); Michael John THOMAS, Ann Arbor, MI (US)

(73) Assignee: JOHNSON CONTROLS TECHNOLOGY COMPANY, Holland, MI (US)

(21) Appl. No.: 14/649,357

(22) PCT Filed: Dec. 5, 2013
(86) PCT No.: PCT/US13/73359

§ 371 Date: Jun. 3, 2015

Related U.S. Application Data
(60) Provisional application No. 61/733,758, filed on Dec. 5, 2012.

(51) Int. Cl. B60N 2/64; B29C 45/14; B60N 2/24; B29C 44/12; G06K 7/10; B60R 13/02

(52) U.S. Cl. CPC B60N 2/646; G06K 7/10366; B60R 13/02; B60N 2/24; B29C 44/1271; B29C 45/14065; B60R 2013/0287; B29K 2075/00

(57) ABSTRACT

A method for manufacturing a vehicle interior component includes securing a radio frequency identification (RFID) tag in a desired position and/or orientation within an internal cavity of a mold using magnetic attraction. The internal cavity is shaped to form the vehicle interior component. The method also includes filling the internal cavity with an expanding foam such that the expanding foam bonds to the RFID tag as the expanding foam cures.

### BACKGROUND

The invention relates generally to a system and method for manufacturing a vehicle interior component having an embedded radio frequency identification tag.

Vehicle seating typically includes a seat bottom and a seat back to support a driver or passenger. In certain seating configurations, both the seat bottom and seat back include a rigid chassis, cushions, and a fabric covering. The cushions are coupled to the rigid chassis, and the fabric covering is disposed about the assembly. The rigid chassis of the seat bottom serves to support the weight (i.e., vertical load) of the occupant, and couples the seat to a floor of the vehicle. Further, the seat cushions provide padding that enhances the comfort of the occupant.

Certain interior components, such as seat cushions, are constructed by injecting an expandable liquid into a mold to form a foam cushion having the shape of the mold cavity. A variety of expandable liquids may be used to create cushions having different firmnesses and/or weights. In addition, different mold cavities may be employed to form cushions having different shapes. Accordingly, identification of individual components throughout the manufacturing process, as well as during post-production maintenance of components within the vehicle, is desirable to facilitate differentiation of similar components. For example, a bar code tag may be coupled to certain cushions to facilitate identification of the cushion with a bar code reader. Unfortunately, the process of attaching bar code tags to vehicle components is time-consuming, thereby increasing the manufacturing cost of the components. In addition, bar code tags may be obscured or blocked by other interior components, thereby increasing the difficulty associated with identifying an installed component.

### BRIEF DESCRIPTION

The present invention relates to a method for manufacturing a vehicle interior component including securing a radio frequency identification (RFID) tag in a desired position and/or orientation within an internal cavity of a mold using magnetic attraction. The internal cavity is shaped to formthe vehicle interior component. The method also includes filling the internal cavity with an expanding foam such that the expanding foam bonds to the RFID tag as the expanding foam cures.

The present invention also relates to a vehicle interior component prepared by a process including securing a radio frequency identification (RFID) tag in a desired position and/or orientation within an internal cavity of a mold using magnetic attraction. The internal cavity is shaped to formthe vehicle interior component. The process also includes filling the internal cavity with an expanding foam such that the expanding foam bonds to the RFID tag as the expanding foam cures. A magnitude of the magnetic attraction is sufficient to secure the RFID tag in the desired position and/or orientation at least until the expanding foam cures.

The present invention further relates to a system for manufacturing a vehicle interior component including a mold having an internal cavity shaped to form the vehicle interior component. The internal cavity is configured to receive a radio frequency identification (RFID) tag in a desired position and/or orientation. The system also includes a magnet configured to establish a magnetic attraction between the RFID tag and the mold. The internal cavity is configured to receive expanding foam, and the expanding foam is configured to bond to the RFID tag as the expanding foam cures.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary vehicle that may include an interior component having an embedded radio frequency identification (RFID) tag.

FIG. 2 is a perspective view of an exemplary vehicle seat that may include a cushion having an embedded RFID tag.

FIG. 3 is a perspective view of an embodiment of a system for forming an interior component having an embedded RFID tag.

FIG. 4 is a schematic flow diagram of an embodiment of a method for forming an interior component having an embedded RFID tag.

FIG. 5 is a perspective view of an embodiment of a vehicle interior component having an embedded RFID tag.

FIG. 6 is a flowchart of an embodiment of a method for manufacturing a vehicle interior component having an embedded RFID tag.

### DETAILED DESCRIPTION

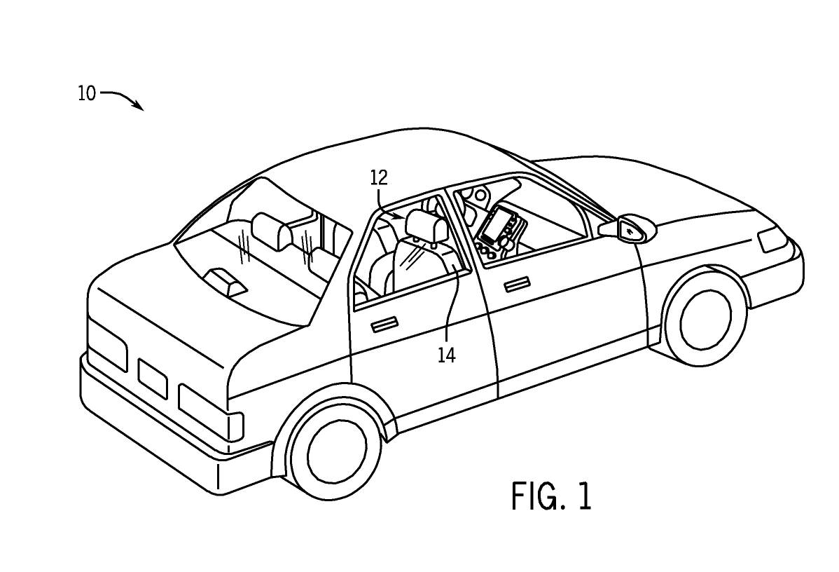

FIG. 1 is a perspective view of an exemplary vehicle 10 that may include an interior component having an embedded radio frequency identification (RFID) tag. As illustrated, the vehicle 10 includes an interior 12 having a seat 14. As discussed in detail below, the seat 14 may include seat cushions having embedded RFID tags. The embedded RFID tags may substantially reduce the time and effort associated with identifying and/or tracking components of the seat, or the seat as a whole. In certain embodiments, an RFID tag may be embedded within a seat cushion during the cushion molding process. For example, an RFID tag is secured in a desired position and/or orientation within an internal cavity of a mold. A liquid expanding foam is then poured into the internal cavity. The foam expands to fill the contours of the internal cavity of the mold, thereby establishing a cushion having a desired shape. In addition, as the foam expands and cures, the foam bonds to the RFID tag secured within the internal cavity (e.g., forms a mechanical bond between the RFID tag and the foam). Accordingly, the completed cushion includes an RFID tag embedded within the foam structure at a desired position and/or orientation. The bond between the RFID tag and the foam may be more secure than a bond established by physically coupling an RFID tag to a completed cushion. In addition, embedding an RFID tag within a foam cushion during the molding process may be less time consuming and/or less labor intensive than physically coupling an RFID tag to a completed cushion. Moreover, because the RFID tag is embedded within the cushion, the cushion may maintain a substantially flat surface, thereby substantially reducing or eliminating the possibility of inadvertently removing the RFID tag during later stages of the seat production process.

While a system and method for em bedding an RFID tag within a seat cushion is described below, it should be appreciated that the system and method may be used to embed RFID tags within other vehicle components. For example, certain elements of a door panel, an instrument panel, and/or an armrest may be formed by injecting expandable foam into a mold cavity. As will be appreciated, the system and method described below may be employed to embed RFID tags within such elements.

As used herein, the terms “embed,” “embedded,” and “embedding” refer to an RFID tag that is at least partially united with a surrounding structure (e.g., a foam cushion of a seat back or seat bottom). It should be appreciated, that an RFID tag may be embedded within a surrounding structure without being fully enclosed within the surrounding structure. For example, as expanding foam fills an internal cavity of a mold, the RFID tag becomes embedded within the foam. As a result, the foam bonds to at least one surface of the RFID tag (e.g., forms a mechanical bond between at least one surface of the RFID tag and the foam). By way of ex ample, if the shape of the RFID tag is a rectangular prism, fives sides of the prism may be in contact (e.g., bonded to) the foam, and the sixth side may be substantially flush with an exterior surface of the completed foam part. In such a configuration, the RFID tag is considered embedded within the foam part.

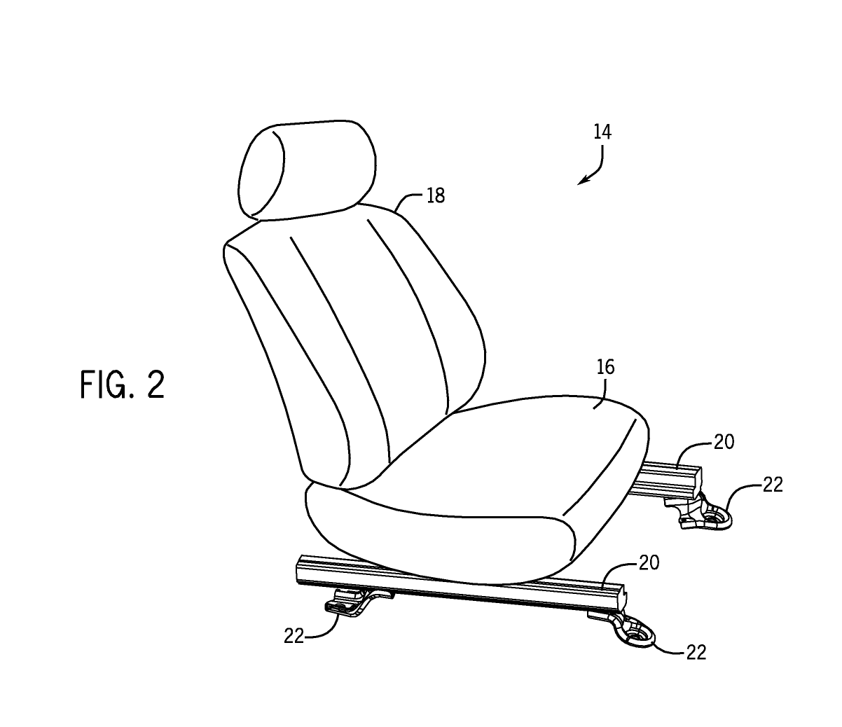

FIG. 2 is a perspective view of the vehicle seat 14 of FIG. 1. As illustrate d, the seat 14 includes a seat bottom assembly 16 and a seat back assembly 18. In the present embodiment, the seat bottom assembly 16 includes a seat bottom chassis, one or more cushions, and a fabric covering. The seat bottom chassis serves to support the weight of an occupant during normal vehicle operation and during high g-force events (e.g., rapid acceleration or deceleration, etc.). The seat bottom chassis also secures the seat bottom assembly 16 to a floor of the vehicle 10, and provides a mounting surface for the seat back assembly 18. One or more cushions may be coupled to the seat bottom chassis to provide passenger comfort, and the fabric covering may be disposed about the cushion to provide a desired appearance and/or to protect the internal components of the seat bottom assembly 16. The seat back assembly 18 may be constructed in a similar manner, i.e., from one or more cushions secured to a rigid chassis and wrapped with a fabric covering. The cushions of the seat bottom assembly 16 and/or the seat back assembly 18 may each include an RFID tag that is em bedded within the cushion during the molding process. Because the RFID tag is embedded during molding, the process of separately attaching a cushion identifier (e.g., an RFID tag, a bar code, etc.) is obviated. As a result, the duration and costs associated with manufacturing a cushion may be substantially reduced. In addition, because the RFID tag communicates via radio frequency signals, an RFID reader may scan an RFID tag positioned outside of a line-of-sight (e.g., an RFID tag obscured or blocked by other interior components), thereby facilitating identification of the cushion.

As illustrated, the seat bottom assembly 16 is secured to a seat track 20. The seat track 20, in turn, is secured to the floor of the vehicle 10 by mounting feet 22. In certain configurations, the seat 14 may be configured to translate along the seat track 20 to adjust a longitudinal position of a driver or passenger. As will be appreciated, adjustment of the seating position may be either manual or assisted. For example, an electric motor may be configured to drive the seat 14 along the track 20 by a suitable mechanism such as a rack and pinion system. In addition, the seat back assembly 18 may be configured to recline with respect to the seat bottom assembly 16. Adjustment of the seat back assembly 18 may also be either manual or assisted by an electric motor, for example.

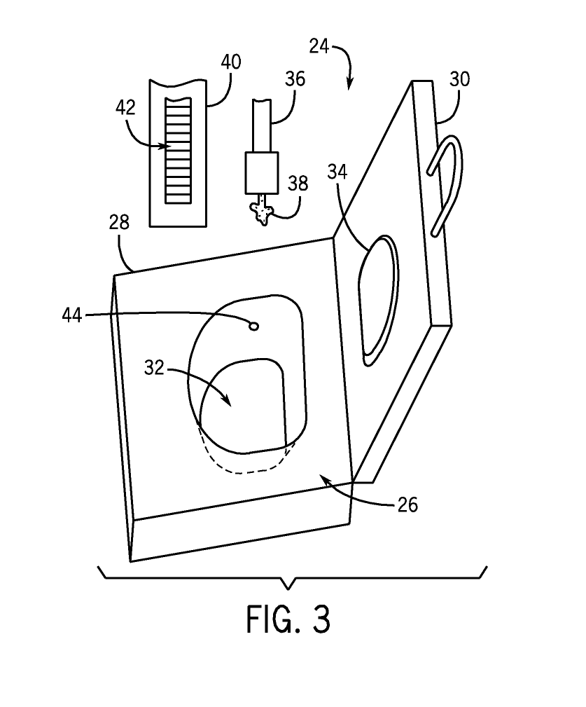

FIG. 3 is a perspective view of an embodiment of a system 24 for forming an interior component having an embedded RFID tag. The system 24 includes a mold 26 configured to form cushions for the seat bottom assembly 16 and/or the seat back assembly 18, for example. In certain embodiments, at least a portion of the mold 26 is formed from cast aluminum. However, it should be appreciated that the mold 26 may include other suitable materials, such as stainless steel or plastic, for example. As illustrated, the mold 26 includes a body 28 and a lid 30, which form a “clamshell” type mold. The body 28 includes an internal cavity 32, which ultimately determines the shape of the interior component. In certain embodiments, the body 28 may include multiple internal cavities to form various elements of one or more interior components. In the illustrated embodiment, the lid 30 is configured to selectively cover an opening in an upper surface of the mold body 28. However, in alternative embodiments, the lid 30 may be configured to selectively cover an opening in a side or bottom surface of the body 28. As illustrated, the lid 30 includes a gasket 34 configured to establish a seal with the internal cavity 32, thereby substantially blocking a flow of expanding foam out of the opening.

The system 24 also includes a pour head 36 positioned above the opening in the internal cavity 32. The pour head 36 is configured to deliver (e.g., pour, inject, etc.) expanding foam 38, such as polyurethane foam, into the internal cavity 32. In certain embodiments, one pour head 36 may sequentially inject foam 38 into several internal cavities 32 to form multiple interior components. After the foam 38 is delivered to the internal cavity 32, the lid 30 may be closed to establish a substantially sealed chamber for forming the interior component. As will be appreciated, the foam 38 expands as it cures, there by filling the internal cavity 32, and forming an interior component having a shape that substantially corresponds to the shape of the internal cavity 32. In certain embodiments, the pour head 36 is moveable to facilitate displacement of the pour head 36 after the foam 38 is delivered to the internal cavity 32, thereby facilitating lid closure.

As discussed in detail below, an RFID tag is secured in a desired position and/or orientation within the internal cavity 32 of the mold 26 prior to injecting the expanding foam 38. As the foam expands and cures, the foam bonds to the RFID tag (e.g., forms a mechanical bond between the RFID tag and the foam), thereby establishing an interior component having an RFID tag embedded within the foam structure. In the illustrated embodiment, the system 24 includes a hopper 40 configured to provide RFID tags 42 to the internal cavity 32. For example, the hopper 40 may be configured to automatically secure an RFID tag in a desired position and/or orientation within the internal cavity 32 of the mold 26. Alternatively, the hopper 40 may provide an RFID tag to an operator, thereby enabling the operator to secure the RFID tag in a desired position and/or orientation within the internal cavity 32 of the mold 26.

As will be appreciated, RFID tags 42 include an antenna and control circuitry. The antenna is both a receiving antenna and a transmitting antenna, designed to resonate at a particular frequency. Electrical energy is transferred from an RFID reader to the RFID tag 42 via a power/interrogation signal, which is received by the RFID tag antenna, and serves to power the control circuitry. The control circuitry holds a small amount of coded information, such as identification data, manufacture date, part number, etc. Certain embodiments employ “passive” control circuitry that does not have an independent power source, and does not initiate transfer of information except in response to a signal from the RFID reader. The power/interrogation signal from the RFID reader powers the control circuitry, and induces the control circuitry to generate a return signal encoded with the data stored in the control circuitry. In the present embodiment, the data may be used to identify a particular interior component, such as a particular cushion within the seat 14.

In the illustrated embodiment, the mold 26 includes a magnet 44 configured to secure the RFID tag 42 in a desired position and/or orientation within the mold cavity 32. For example, a ferromagnetic material or another magnetic within the RFID tag 42 may be magnetically attracted to the magnet 44, thereby facilitating attachment of the RFID tag 42 to the internal cavity 32. The magnitude of the magnetic attraction may be particularly selected (e.g., by adjusting the strength of the magnet) to secure the RFID tag 42 in the desired position and/or orientation within the internal cavity 32 of the mold body 28 at least until the expanding foam cures. As a result, the RFID tag 42 may be located at a desired position and/or orientation within the completed foam part.

As used herein, the term “ferromagnetic” refers to any material that is attracted to a magnetic field. Accordingly, ferromagnetic materials include materials that may be considered ferrimagnetic. By way of example, ferromagnetic materials include iron, nickel, cobalt, compounds formed from certain rare earth elements, and various metallic alloys. However, it should be appreciated that any suitable ferromagnetic material may be utilized within the system 24.

It should be appreciated that the magnet 44 may be a permanent magnetic or an electromagnetic. For example, one or more permanent magnets may be embedded within the internal cavity 32 of the mold body 28. An operator or an automated system may place each RFID tag 42 adjacent to a respective magnet 44. Magnetic attraction between the magnet 44 and a ferromagnetic material and/or another magnet within the RFID tag 42 holds the RFID tag in the desired position and/or orientation at least until the expanding foam cures. Alternatively, one or more electromagnets may be positioned to hold each RFID tag 42 in the desired position and/or orientation. In certain embodiments, the electromagnet may be activated prior to placement of the RFID tags within the internal cavity 32 of the mold body 28. The electromagnet may remain magnetized through the RFID tag placement process, and the liquid foam pouring/injection process. However, once the foam expands and cures, the electromagnet may be deactivated to facilitate removal of the completed foam part from the mold 26.

While the illustrated embodiment includes a discrete magnet 44 embedded within the internal cavity 32, it should be appreciated that in alternative embodiments, the entire mold 26, or a portion of the mold 26, may be magnetized. In such embodiments, the RFID tag may be secured to the mold in a variety of positions and/or orientations. In further embodiments, at least a portion of the mold 26 may include a ferromagnetic material, and the RFID tag 42 may include a magnet. In such embodiments, the RFID tag 42 may be secured to the internal cavity 32 of the mold body 28 by magnetic attraction between the magnet and the ferromagnetic material. For example, the entire mold 26 may be formed from a ferromagnetic material. Alternatively, the mold 26 may include a ferromagnetic portion configured to secure the RFID tag within a desired region of the internal cavity 32.

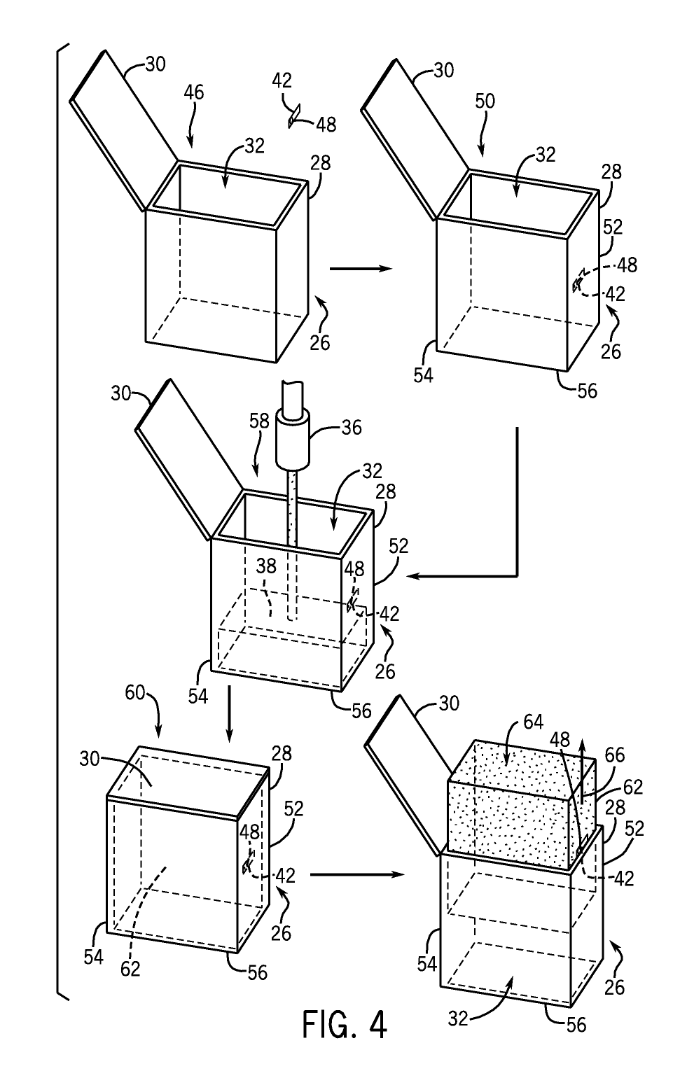

FIG. 4 is a schematic flow diagram of an embodiment of a method of forming an interior component having an embedded RFID tag. First, as represented by step 46, the lid 30 of the mold 26 is in an open position, thereby enabling expandable foam to be deposited into the internal cavity 32 of the mold body 28. In the illustrated embodiment, at least a portion of the mold 26 includes a ferromagnetic material, and the RFID tag 42 includes a magnet 48 that is magnetically attracted to the ferromagnetic material. However, it should be appreciated that in alternative embodiments, at least a portion of the RFID tag includes a ferromagnetic material, and the mold includes a magnet that is magnetically attracted to the ferromagnetic material. In further embodiments, the RFID tag includes a first magnet, and the mold includes a second magnet that is magnetically attracted to the first magnet. In addition, while the illustrated embodiment includes a substantially cubical mold 26, it should be appreciated that more complex mold shapes may be employed in alternative embodiments.

Before being filled with expandable foam, at least one RFID tag 42 is secured in a desired position and/or orientation within the internal cavity 32 of the mold 26 using magnetic attraction, as represented by step 50. The magnet 48 of the RFID tag 42 is attracted to the ferromagnetic material of the mold 26, thereby securing the RFID tag 42 to the internal cavity 32 of the mold body 28. In the illustrated embodiment, the RFID tag 42 is secured substantially flat against a first surface 52 of the internal cavity 32. However, it should be appreciated that the RFID tag 42 and/or additional RFID tags may be secured to a second surface 54, a third surface 56, and/or any other suitable surface of the internal cavity 32. As will be appreciated, the process of securing the RFID tag within the internal cavity may be performed manually, or automatically (e.g., via the hopper 40).

Once the RFID tag is attached to the mold 26, as represented by step 58, the pour head 36 deposits or injects the expanding foam 38 into the internal cavity 32. As previously discussed, the foam 38 may be a polyurethane foam, or another type of suitable liquid expanding foam. Depending on the composition of the foam, a variety of components having different hardnesses and/or weights may be formed. If the component is a seat bottom cushion, a softer foam may be employed, and if the component is part of a headrest or a dashboard, a harder foam may be employed.

After the foam is deposited within the internal cavity 32, it expands and cures. As represented by step 60, the lid 30 is closed to enable the foam to completely fill the internal cavity 32 of the mold 26, thereby forming a foam component 62 having a shape substantially corresponding to the shape of the internal cavity 32. Because the RFID tag 42 is secured substantially flat against the first surface 52 of the internal cavity 32, the RFID tag 42 becomes embedded substantially flush with a corresponding external surface of the foam component 62. When the foam has finished curing, as represented by step 64, the foam component 62 is extracted from the mold in a direction 66. Because the RFID tag is embedded within the foam component, the component 62 may be tracked as it travels through the production process, and identified after it has left the production facility.

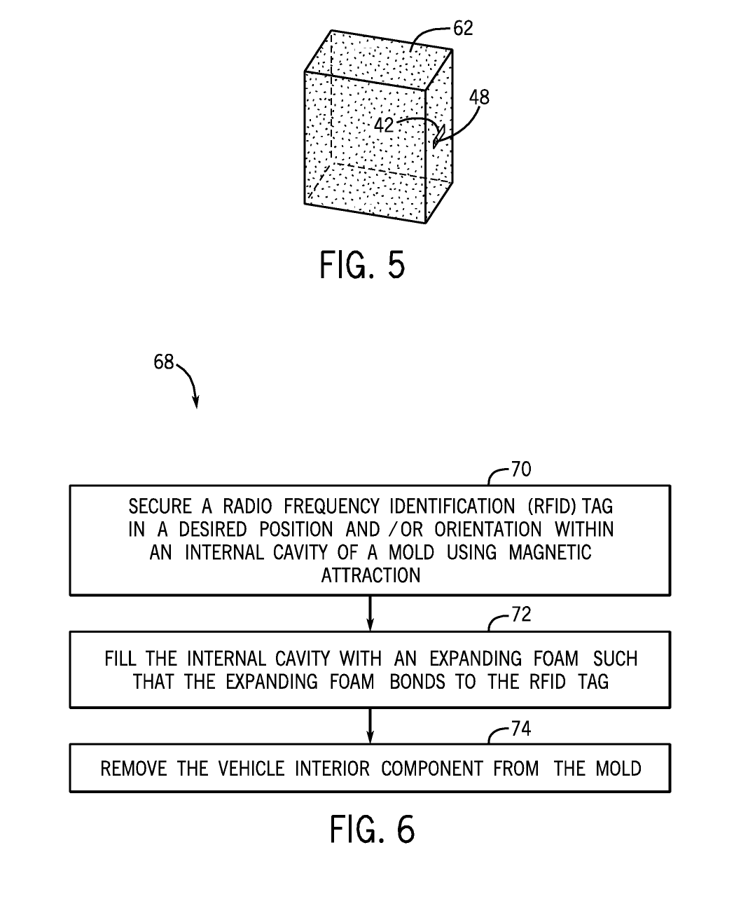

FIG. 5 is a perspective view of an embodiment of a vehicle interior component 62 having an em bedded RFID tag 42. While the illustrated embodiment includes a substantially cubical interior component 62, it should be appreciated that alternative embodiments may include interior components having a variety of shapes and/or sizes based on the desired application of the component. In certain embodiments, the foam of the component 62 may be substantially homogenous due to uniform expansion of the foam within the internal cavity of the mold. In the illustrated embodiment, a single RFID tag is embedded within a respective surface of the vehicle interior component 62. However, it should be appreciated that certain embodiments may include more RFID tags (e.g., 2, 3, 4, 5, 6, or more) embedded within one or more surfaces of the component 62, and/or within an interior of the component 62. In the illustrated embodiment, the RFID tag 42 is embedded within a surface of the component 62 such that the RFID tag 42 is substantially flush with the surface. Accordingly, communication with an RFID reader positioned adjacent to the surface may be substantially enhanced, as compared to RFID tags that are angled relative to the surface. In addition, because the RFID tag is substantially flush with the respective surface, the inter for component may have a substantially smooth surface, thereby enhancing the appearance of the component.

FIG. 6 is a flowchart of an embodiment of a method 68 for manufacturing a vehicle interior component having an embedded RFID tag. First, as represented by block 70, an RFID tag is secured in a desired position and/or orientation within an internal cavity of a mold using magnetic attraction. For example, at least a portion of the mold may include a ferromagnetic material, and the RFID tag may include a magnet that is magnetically attracted to the ferromagnetic material. Alternatively, at least a portion of the RFID tag may include a ferromagnetic material, and the mold may include a magnet that is magnetically attracted to the ferromagnetic material. In further embodiments, the RFID tag may include a first magnet and the mold may include a second magnet. Magnetic attraction between the first and second magnets holds the RFID tag in the desired position and/or orientation within the internal cavity of the mold. Next, as represented by block 72, the internal cavity of the mold is filled with expanding foam. The foam expands to fill the contours of the internal cavity of the mold, thereby establishing an interior component having a desired shape. In addition, as the foam expands and cures, the foam bonds to the RFID tag secured within the internal cavity (e.g., forms a mechanical bond between the RFID tag and the foam). Accordingly, the completed interior component includes an RFID tag embedded within the foam structure at a de sired position and/or orientation. At block 74, the cured vehicle interior component is removed from the mold. Embedding an RFID tag within an interior component during the molding process may be less time consuming and/or less labor intensive than physically coupling an RFID tag to a completed component. Accordingly, the manufacturing costs of foam vehicle interior components may be substantially reduced.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for manufacturing a vehicle interior component comprising:
securing a radio frequency identification (RFID) tag in a desired position, orientation, or a combination thereof, within an internal cavity of a mold using magnetic attraction, wherein the internal cavity is shaped to form the vehicle interior component; and
filling the internal cavity with an expanding foam such that the expanding foam bonds to the RFID tag as the expanding foam cures.

2. The method of claim 1, wherein at least a portion of the mold comprises a ferromagnetic material, and the RFID tag comprises a magnet that is magnetically attracted to the ferromagnetic material.

3. The method of claim 1, wherein at least a portion of the RFID tag comprises a ferromagnetic material, and the mold comprises a magnet that is magnetically attracted to the ferromagnetic material.

4. The method of claim 1, wherein the RFID tag comprises a first magnet, the mold comprises a second magnet, and the first and second magnets are magnetically attracted to one another.

5. The method of claim 1, wherein a magnitude of the magnetic attraction is sufficient to secure the RFID tag in the desired position, orientation, or a combination thereof, at least until the expanding foam cures.

6. The method of claim 1, wherein the desired position, orientation, or a combination thereof, is substantially flat against a surface of the internal cavity.

7. The method of claim 1, comprising removing the vehicle interior component from the mold after the expanding foam has cured.

8. A vehicle interior component prepared by a process, comprising:
securing a radio frequency identification (RFID) tag in a desired position, orientation, or a combination thereof, within an internal cavity of a mold using magnetic attraction, wherein the internal cavity is shaped to form the vehicle interior component; and
filling the internal cavity with an expanding foam such that the expanding foam bonds to the RFID tag as the expanding foam cures, wherein a magnitude of the magnetic attraction is sufficient to secure the RFID tag in the desired position, orientation, or a combination thereof, at least until the expanding foam cures.

9. The vehicle interior component of claim 8, wherein the RFID tag, the mold, or a combination thereof, comprises a magnet.

10. The vehicle interior component of claim 8, wherein the process comprises removing the vehicle interior component from the mold after the expanding foam has cured.

11. The vehicle interior component of claim 8, wherein the desired position, orientation, or a combination thereof, is selected such that the RFID tag is readable by an RFID reader external to the vehicle interior component.

12. The vehicle interior component of claim 8, wherein the vehicle interior component comprises a cushion for a seat back assembly, or a cushion for a seat bottom assembly.

13. A system for manufacturing a vehicle interior component comprising: a
mold having an internal cavity shaped to form the vehicle interior component, wherein the internal cavity is configured to receive a radio frequency identification (RFID) tag in a desired position, orientation, or a combination thereof; and
a magnet configured to establish a magnetic attraction between the RFID tag and the mold;
wherein the internal cavity is configured to receive expanding foam, and the expanding foam is configured to bond to the RFID tag as the expanding foam cures.

14. The system of claim 13, wherein the magnet is disposed within the RFID tag.

15. The system of claim 13, wherein the magnet is disposed within the mold.

16. The system of claim 13, comprising a hopper configured to hold a plurality of RFID tags, and to sequentially dispense the plurality of RFID tags into the internal cavity of the mold.

17. The system of claim 13, wherein the mold comprises a base having the internal cavity, and a lid configured to selectively cover the internal cavity.

18. The system of claim 13, wherein a magnitude of the magnetic attraction is sufficient to secure the RFID tag in the desired position, orientation, or a combination thereof, at least until the expanding foam cures.

19. The system of claim 13, wherein the vehicle interior component comprises a cushion for a seat back assembly.

20. The system of claim 13, wherein the vehicle interior component comprises a cushion for a seat bottom assembly.
